(19) United States
(12) Patent Application Publication
(10) Pub. No.: US 2001/0047566 A1
(43) Pub. Date: Dec. 6, 2001

(54) Fastening plate to fasten a hinge arm of a furniture hinge

(76) Inventor: Luciano Salice, Carimate (IT)

Correspondence Address: JACOBSON HOLMAN PLLC, 400 SEVENTH STREET N.W., SUITE 600, WASHINGTON, DC, 20004, US

(21) Appl. No.: 09/858,665

(22) Filed: May 17, 2001

(30) Foreign Application Priority Data
May 24, 2000 (DE) 200 09 317.7

(51) Int. Cl. E05D 7/04

(52) U.S. Cl. 16/242

(57) ABSTRACT

A fastening plate to fasten a hinge arm of a furniture hinge The invention relates to a fastening plate to fasten a hinge arm of a furniture hinge to a carrier wall consisting of an elongated base plate having at least two boreholes to receive fastening elements, of a cover plate covering the base plate at least in part and being guided in a transversely displaceable manner thereon, and of an eccentric to displace the cover plate with respect to the base plate. In accordance with the invention, the base plate has in its central region at least one lower tang bent down through 180 degrees whose lateral edges are supported at the inner lateral edges of tangs bent down through 180 degrees at the cover plate.

The invention relates to a fastening plate to fasten a hinge arm of a furniture hinge in accordance with the preamble of claim 1.

A generic fastening plate to fasten a hinge arm of a furniture hinge to a carrying wall is already known from DE 94 09 459 U. This consists of an elongated base plate having at least two boreholes to receive fastening elements, a cover plate covering the base plate at least in part and being guided in a transversely displaceable manner thereon and an eccentric to displace the cover plate with respect to the base plate. As the fastening screw for the hinge arm is located in the central region of the cover plate in this embodiment, the eccentric is offset and accessibly arranged by an appropriately arranged recess of the hinge arm. A symmetrical mounting of the fastening plate is thus not possible.

A vertically adjustable hinge having a fastening plate is known from EP 947655 A, wherein the eccentric is located at the intersection of the centre lines of the projecting centre piece and the lateral extensions of the cover plate, since in this case it is a clip hinge which does not require a fastening screw for the hinge arm. This symmetrical fastening plate has a cruciform shape. The assembly of the fastening plate from the individual components is particularly complex here.

A fastening plate made of steel and vertically adjustable by an eccentric is known from EP 790378, wherein the base plate is formed from two part plates which are located at sides of the projecting anchoring part of the cover plate opposite one another. The part plates are connected by a web beneath the projecting anchoring part in the mounting position, whereas lateral extensions of the cover plate are arranged beneath both part plates. Both plates can be held together by an additional bolt before the mounting of the fastening plate to the body side wall. This fastening plate also has a complex manufacturing process.

The object of the present invention consists of providing a symmetrical longitudinal fastening plate for fastening a hinge arm of a furniture hinge made of steel, which allows a simple vertical adjustment of clip hinges and can be manufactured particularly simply and at low cost.

This object is solved in accordance with the invention by a generic fastening plate having the features of the preamble to claim 1 by the combination with the characterising features of claim 1. Accordingly, the base plate has in its central region at least one lower tang bent through 180 degrees whose lateral edges are supported at the inner lateral edges of tangs bent downwards through 180 degrees. The fastening plate formed in this way, unlike the prior art, has no back-cuts or undercuts. The secure hold and the light guidance for the transverse displaceability of the cover plate with respect to the base plate is ensured by the folded tangs which support one another at their edge regions. In this way, a low cost and symmetrical arrangement of a longitudinal mounting plate made of steel for the fastening of clip hinges is created which allows vertical adjustment by an eccentric.

Preferred embodiments of the invention can be found in the dependent claims following the main claim.

For instance, the shaft of the eccentric can penetrate a central longitudinally directed elongate aperture, whose width corresponds to the shaft diameter, in the web part of the cover plate and its lower, eccentric shaft part of a lower diameter can be pivoted in a central borehole of the base plate.

Further details and advantages of the invention can be seen in an embodiment shown in the drawing, which shows:

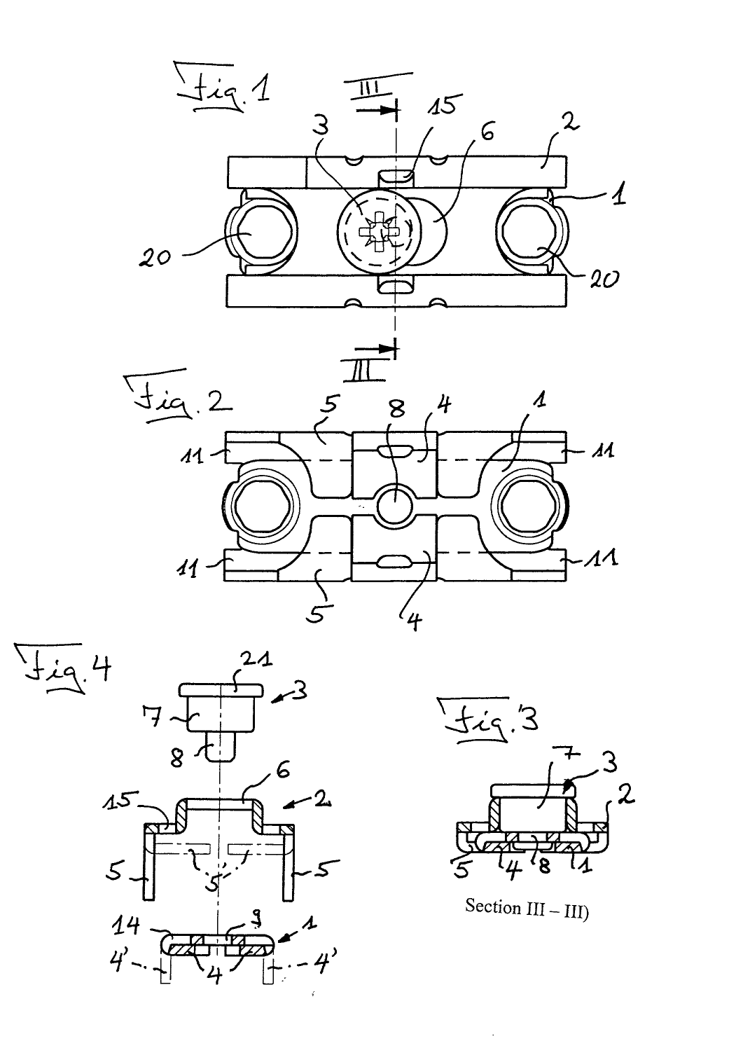

FIG. 1: a plan view of an embodiment of the fastening plate in accordance with the invention;

FIG. 2: a bottom view of the fastening plate in accordance with FIG. 1;

FIG. 3: a section in accordance with the section line III-III in FIG. 1;

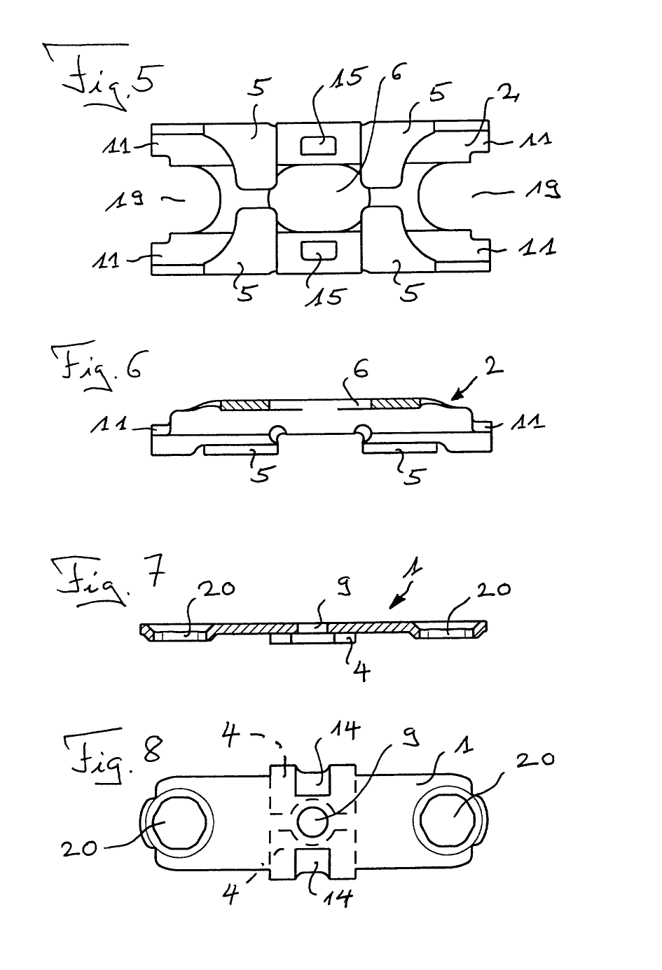

FIG. 4: the representation in accordance with FIG. 3, in which the individual components are drawn apart in an exploded view;

FIG. 5: a bottom view of the cover plate in accordance with the embodiment of FIG. 1;

FIG. 6: a side view of the cover plate in accordance with FIG. 4;

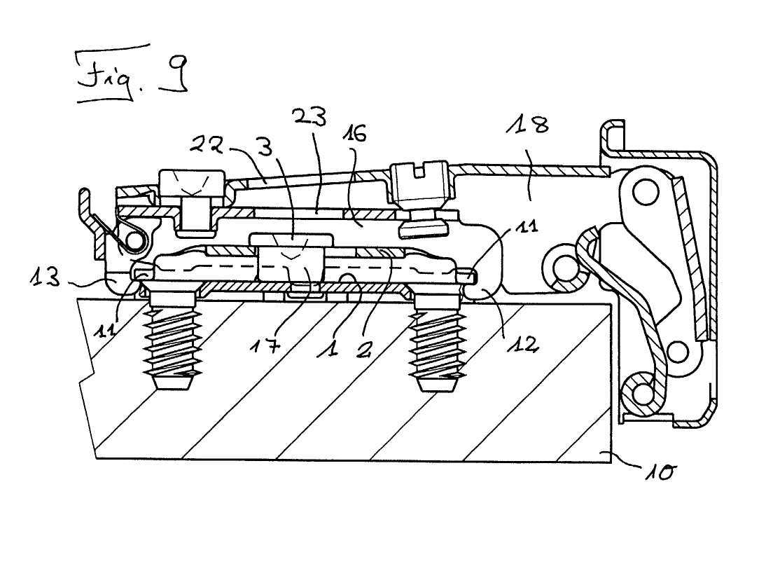

FIG. 7: a side view of the base plate of the embodiment of the fastening plate in accordance with FIG. 1;

FIG. 8: a plan view of the base plate in accordance with FIG. 7; and

FIG. 9: a sectional representation of the fastening plate in accordance with FIG. 1 with an attached hinge arm of a furniture hinge, mounted at a carrier wall.

The fastening plate shown in the FIGS. 1 to 3 essentially consists of a base plate 1, a cover plate 2 and an eccentric 3. The simple manufacturing and mounting method based on the invention can be explained in particular by means of FIG. 4. The base plate 1 has lateral tangs 4′ which are directed downwards and which are bent down into the final position 4 either before or during the assembly of all parts. The cover plate 2 is also provided on both sides with two separate tangs 5 directed downwards which are bent down into the position 5′ while being put together so that they are located in the position best seen in FIG. 2. Finally, the eccentric 3 is inserted into the elongate aperture 6 such that its shaft 7 is supported at the edges of the elongate aperture. A lower eccentric shaft part 8 of the eccentric 3 is riveted into a borehole 9 of the base plate 1 so that the eccentric 3 is rotatably joumalled in the borehole 9. The cover plate 2 is displaced with respect to the base plate 1 by turning the eccentric 3.

It can be seen in particular from FIG. 2 that the edges of the tangs 4 of the base plate 1 are supported at the inner edges of the tangs 5 of the cover plate 2 so that these tangs form a guide in the transverse direction. At the same time, the tangs 5 surround the base plate such that the cover plate 2 is held inseparably from the base plate 1, while its respective adjustment in the transverse direction can be carried out only by turning the eccentric 3 provided with a slot for a screwdriver. Appropriately, the elongate aperture 6 and the borehole 9 are located in the central region of the respective plates so that their design is symmetrical.

The base plate 1 and the cover plate 2 can be seen from the FIGS. 5 to 8, with FIG. 5 illustrating a bottom view of the cover plate 2, FIGS. 6 and 7 each illustrating a longitudinal section through both plates and FIG. 8 illustrating a plan view of the base plate 1. FIG. 9 shows a longitudinal section through the fastening plate with a mounted clip hinge fastened to a body side wall 10. The structure of the clip hinge is not looked at in any further detail here since it is known per se in the prior art. Reference is only made here to the fact that the end regions of the cover plate 2 are provided with lateral web parts 11 which serve the anchoring of both the front hooks 12 of an intermediate plate 16 of the hinge arm 18 and of a rear latch lever 13.

The base plate 1 is furthermore provided with recesses 14 and the cover plate 2 with slots 15 which serve in the mounted state to receive wedge-shaped extensions 17 provided centrally on the walls of the intermediate plate 16.

Finally, the base plate 1 is provided in a known manner with fastening boreholes 20 for fastening means which are accessible through recesses 19 of the cover plate 2.

The eccentric 3 can have a head 21 which can be actuated by a screwdriver by slots 22 or 23 respectively provided in the web part of the hinge arm 18 and the intermediate plate 16.

1. A fastening plate to fasten a hinge arm of a furniture hinge to a carrier wall, consisting of an elongated base plate (1) having at least two boreholes (20) to receive fastening elements, of a cover plate (2) covering the base plate (1) at least in part and being guided in a transversely displaceable manner thereon and of an eccentric (3) to displace the cover plate (2) with respect to the base plate (1), characterised in that the base plate (1) has at its central region at least one lower tang (4) bent down through 180 degrees whose lateral edges are supported at the inner lateral edges of tangs (5) bent down through 180 degrees at the cover plate (2).

2. A fastening plate in accordance with claim 1, wherein the eccentric (3) has a shaft (7) with which it penetrates a central elongate aperture (6) oriented in the longitudinal direction of the cover plate (2), with the width of said elongate aperture (6) corresponding to the diameter of the shaft (7) and wherein the eccentric has an eccentric shaft part (8) below the shaft (7), which has a lesser diameter than the shaft (7), with the eccentric shaft part (8) being pivoted in a borehole (9) centrally arranged in the base plate (1).

3. A fastening plate in accordance with either of claims 1 or 2, wherein the base plate (1) has two equally long tangs (4) in its central region.

4. A fastening plate in accordance with any of claims 1 to 3, wherein the end regions of the cover plate (2) are provided with lateral web parts (11) which serve the anchoring of an attachable hinge arm (18).

5. A fastening plate in accordance with any of claims 1 to 4, wherein slots (15) are recessed in the cover plate (2) which serve to receive wedge-shaped extensions which are moulded directly on the furniture hinge to be fastened or on an intermediate plate (16) connected thereto.

6. A fastening plate in accordance with any of claims 1 to 5, wherein the eccentric (3) has a screw head (21) which can be actuated by corresponding slots (22, 23) in the attached hinge arm (18) and, optionally, of the intermediate plate (16) provided.

7. A fastening plate in accordance with any of claims 1 to 6, wherein the base plate (1) and/or the cover plate (2) are designed symmetrically to their longitudinal and transverse central axes.

8. A method to manufacture a fastening plate in accordance with any of claims 1 to 7, characterised in that the bent down tangs (5) are bent down during the putting together of the components.
